(19) United States
(12) Patent Application Publication
(10) Pub. No.: US 2005/0167205 A1
(43) Pub. Date: Aug. 4, 2005

(54) Elevator monitor system and computer-readable recording medium in which elevator monitor program has been stored

(75) Inventors: Shigeki Yamakawa, Tokyo (JP); Masaaki Amano, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Chiyoda-ku, Tokyo (JP)

(21) Appl. No.: 10/513,251

(22) PCT Filed: Jun. 20, 2003
(86) PCT No.: PCT/JP03/07875

(51) Int. Cl. B66B 1/34

(52) U.S. Cl. 187/391

(57) ABSTRACT

An elevating machine monitoring system has a monitoring display information file that stores monitoring display information relating to an elevating machine. A monitoring display information change acceptor accepts a request for changing the monitoring display information from a client, and a monitoring display information updater updates the monitoring display information, for which a change has been requested, in the monitoring display information file. A monitoring display information transmission request accepter accepts a request for transmitting the monitoring display information from the client, and a monitoring display information display allows the client to display the monitoring display information after updating, for which transmission has been requested, by referring to the monitoring display information file.

### TECHNICAL FIELD

The present invention relates to an elevating machine monitoring system that monitors an elevating machine such as an elevator, and to a computer readable recording medium on which an elevating machine monitoring program for operating the elevating machine monitoring system is recorded.

### BACKGROUND ART

A conventional remote control system, for example, the remote control system as disclosed in JP2002-114456A, displays information about operation states of an elevator, which is a control object, on a portable information terminal. However, with the conventional remote control system, the content of the display relating to the operation states cannot be changed according to the demands of a user. The conventional remote control system has a problem in that monitoring services that correspond to the demands of the user cannot be performed.

The present invention has been made in order to solve the problem stated above. An object of the present invention is to obtain an elevating machine monitoring system that enables monitoring services for the elevating machine to be offered according to the demands of a user, and a computer readable recording medium on which an elevating machine monitoring program for operating the elevating machine monitoring system is recorded.

To this end, according to one aspect of the present invention, there is provided an elevating machine monitoring system, comprising: monitoring display information storage means for storing monitoring display information relating to an elevating machine; monitoring display information change accepting means for accepting a request for changing the monitoring display information; monitoring display information updating means for updating the monitoring display information, for which a change has been requested, in the monitoring display information storage means; monitoring display information transmission request accepting means for accepting a request for transmitting the monitoring display information; and monitoring display information displaying means for allowing an external portion to display the monitoring display information after updating, for which transmission has been requested, by referring to the monitoring display information storage means.

According to another aspect of the present invention, there is provided an elevating machine monitoring system, comprising: operation control command storage means for storing an operation control command relating to an elevating machine; elevating machine management mode storage means for storing associations between the elevating machine and an elevating machine control device that controls the elevating machine; operation control request accepting means for accepting a request for operation control relating to the elevating machine; operation control request specifying means for specifying an operation control command, which has been requested for operation control, by referring to the operation control command storage means, and for specifying an elevating machine control device, which controls the elevating machine for which operation control has been requested, by referring to the elevating machine management mode storage means; and operation control command outputting means for outputting the operation control command specified by the operation control request specifying means and relating to the elevating machine for which operation control has been requested, to the elevating machine control device specified by the operation control request specifying means, for controlling the elevating machine for which operation control has been requested according to the operation control command.

According to a still further aspect of the present invention, there is provided a computer readable recording medium having an elevating machine monitoring program recovered thereon, the elevating machine monitoring program causing: monitoring display information change accepting means to execute a step of accepting a request for changing monitoring display information; monitoring display information updating means to execute a step of updating monitoring display information, for which change has been requested in monitoring display information storage means; monitoring display information transmission request accepting means to execute a step of accepting a request for transmitting the monitoring display information; and monitoring display information displaying means to execute a step of allowing an external portion to display the monitoring display information after updating, for which transmission has been requested, by referring to the monitoring display information storage means that stores the monitoring display information relating to the elevating machine.

According to a still further aspect of the present invention, there is provided a computer readable recording medium having an elevating machine monitoring program recorded thereon, the elevating machine monitoring program causing: operation control request accepting means to execute a step of accepting an operation control request relating to an elevating machine; operation control request specifying means to execute a step of specifying an operation control command, which has been requested for operation control, by referring to operation control command storage means that stores operation control commands relating to the elevating machine, and specifying an elevating machine control device that controls the elevating machine, for which operation control has been requested, by referring to elevating machine management mode storage means that stores associations between the elevating machine and the elevating machine control device that controls the elevating machine; and operation control command outputting means to execute a step of outputting the operation control command specified by the operation control request specifying means and relating to the elevating machine, for which operation control has been requested, to the elevating machine control device specified by the operation control request specifying means for controlling the elevating machine, for which operation control has been requested, according to the operation control command.

### BRIEF DESCRIPTION OF THE DRAWINGS

FIG. 1 is a diagram that shows the overall configuration of an elevating machine monitoring system according to an embodiment of the present invention.

FIG. 2 is a diagram that shows a data structure for a monitoring display information file shown in FIG. 1.

FIG. 3 is a diagram that shows a data structure for the monitoring display information file by language shown in FIG. 1.

FIG. 4 is a diagram that shows a data structure for an elevator management mode file shown in FIG. 1.

FIG. 5 is a diagram that shows a data structure for an escalator management mode file shown in FIG. 1.

FIG. 6 is a flowchart that shows operations for allowing a client to display monitoring display information, which are operations of an elevating machine monitoring system.

FIG. 7 is a flowchart that shows operations for outputting operation control commands, which are operations of an elevating machine monitoring system, to an elevator control device.

### BEST MODE FOR CARRYING OUT THE INVENTION

### Embodiment

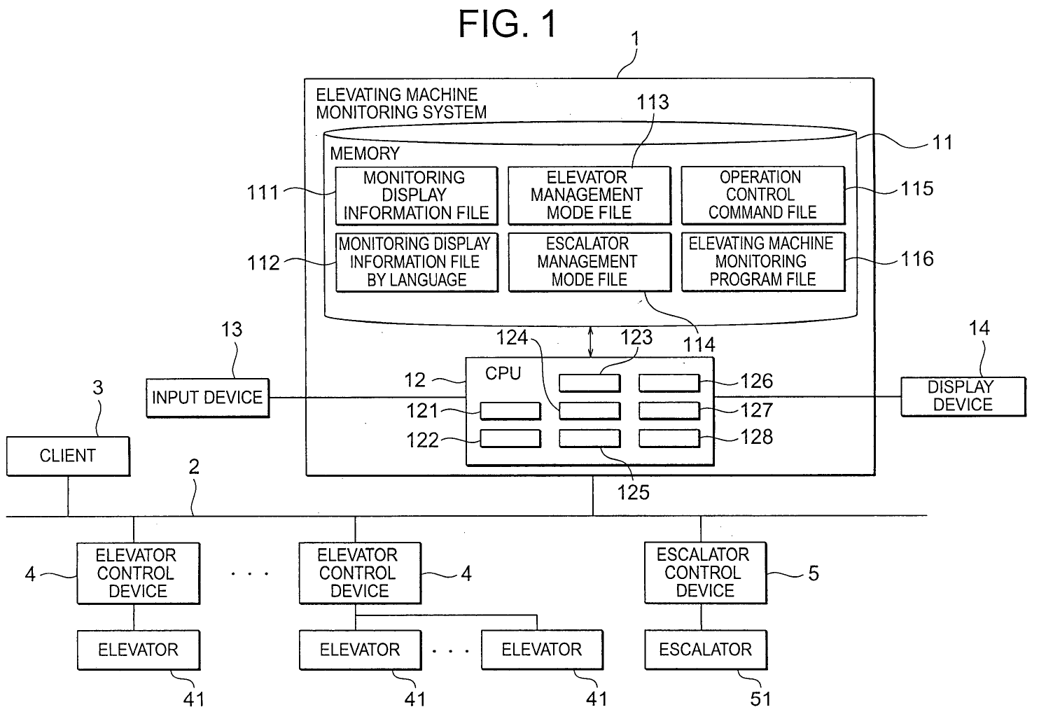

FIG. 1 is a diagram that shows the overall configuration of an elevating machine monitoring system according to an embodiment of the present invention. A case where the elevating machine monitoring system monitors an elevating machine installed within a building physical plant is explained here by way of example.

In FIG. 1, an elevating machine monitoring system 1 is connected to a client (external portion) 3 through a communication network 2. The communication network 2 is a LAN (Local Area Network), for example. Further, the elevating machine monitoring system 1 is connected to a plurality of elevator control devices 4, and to an escalator control device 5 (these devices are referred to generically as “elevating machine control devices”), through the communication network 2. Each of the elevator control devices 4 controls an elevator 41 placed under the control of the device. Further, the escalator control device 5 controls an escalator 51 placed under the control of the device.

The elevating machine monitoring system 1 has a memory 11 and a CPU 12. The CPU 12 is connected to an input device 13 and to a display device (external portion) 14. For example, a personal computer server is used for the elevating machine monitoring system 1. The input device 13 is a mouse or a keyboard, for example, and the display device 14 is a computer display, for example.

A monitoring display information file (monitoring display information storage means) 111 and a monitoring display information file by language (monitoring display information storage means by language) 112 are stored in the memory 11. Further, an elevator management mode file 113 and an escalator management mode file 114 (the management mode files are called “elevating machine management mode storage means”) are stored in the memory 11. In addition, an operation control command file 115 and an elevating machine monitoring program file 116 are stored in the memory 11. The files are explained below.

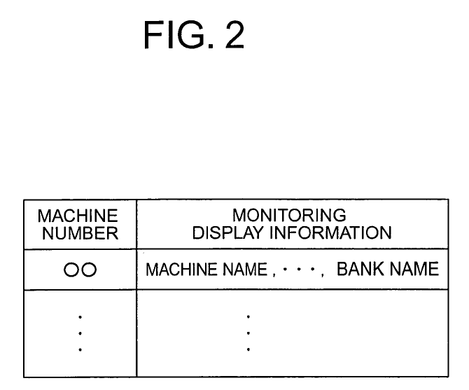

The monitoring display information file 111 stores monitoring display information relating to an elevating machine. FIG. 2 shows the data structure of the monitoring display information file 111. Referring to FIG. 2, monitoring display information relating to elevating machines (the elevators 41 and the escalator 51) is stored in the monitoring display information file 111 for each machine number (for each elevating machine). The monitoring display information includes information such as operating state and monitoring state of the elevating machines. For example, the monitoring display information includes individual machine names, bank names, floors at which elevators stop, floors from which elevators depart, in-operation information, car locations, and operating directions.

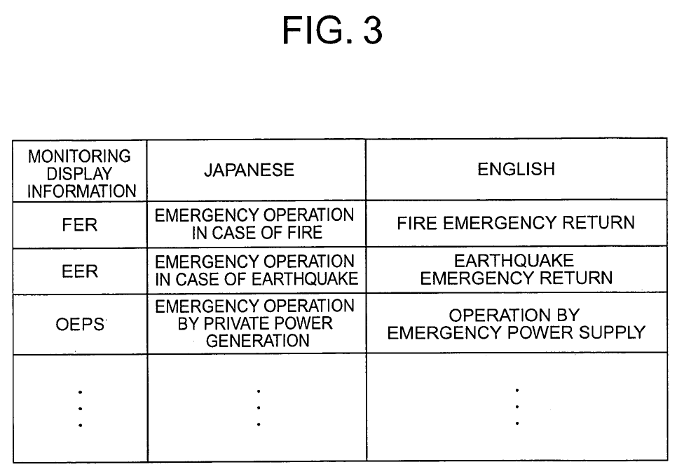

The monitoring display information file by language (monitoring display information storage means) 112 stores monitoring display information displayed in plural languages, by language. FIG. 3 shows the data structure of the monitoring display information file by language 112. Referring to FIG. 3, monitoring display information such as “FER”, which indicates emergency operation in case of fire, is stored in the monitoring display information file by language 112 in the different languages of Japanese and English. It should be noted that the monitoring display information described above is described in Unicode, for example. Associations between the monitoring display information and each language are made by using a pointer, for example.

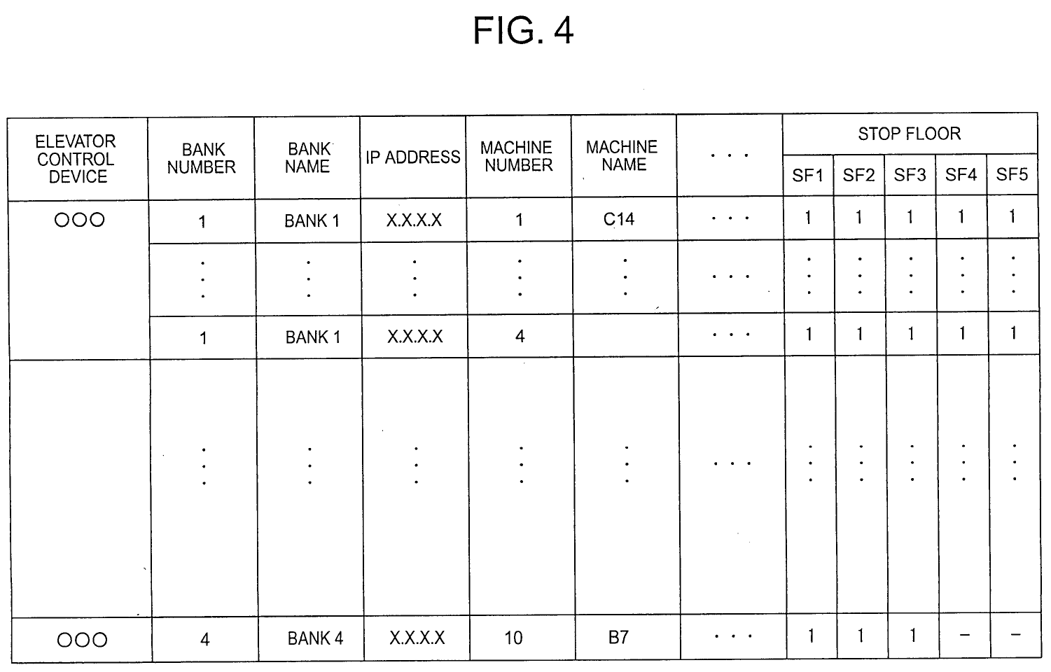

The elevator management mode file 113 stores associations between the elevator 41 and the elevator control device 4. The associations are made based on the machine number of the elevator 41 and the name of the elevator control device. FIG. 4 shows the data structure of the elevator management mode file 113. Referring to FIG. 4, various types of information, such as bank number, bank name, IP address (the address of the elevator control device 4), machine number, machine name (e.g., C14), and floor at which an elevator stops (e.g., SF1) are associated for each elevator control device name.

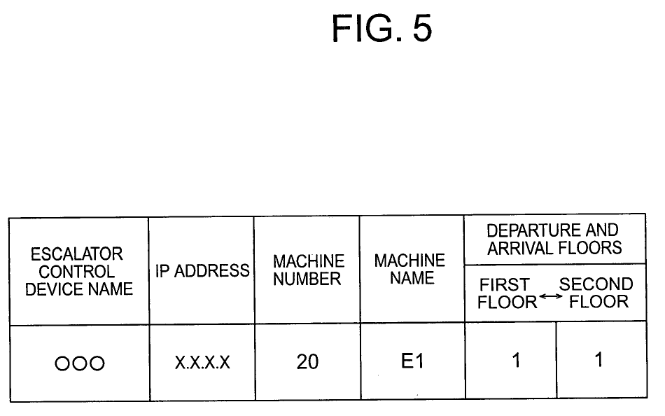

The escalator management mode file 114 stores associations between the escalator 51 and the escalator control device 5. The associations are made based on the machine number (20, for example) of the escalator 51 and the name of the escalator control device. FIG. 5 shows the data structure of the elevator management mode file 114. Referring to FIG. 5, various types of information, such as IPaddress (the address of the escalator control device 5), machine number, machine name, and departure and arrival floor are associated with the escalator control device name.

The operation control command file 115 stores operation control commands (commands) according to operation control content. The operation control content includes normal operation, operation stop, operation pause, non-stop floor settings, operation in case of fire, and operation in case of earthquake.

The elevating machine monitoring program file 116 stores an elevating machine monitoring program for operating the elevating machine monitoring system 1. The elevating machine monitoring program is read in from a recording medium such as a CD-ROM. However, the elevating machine monitoring program may also be stored in advance in the elevating machine monitoring program file 116.

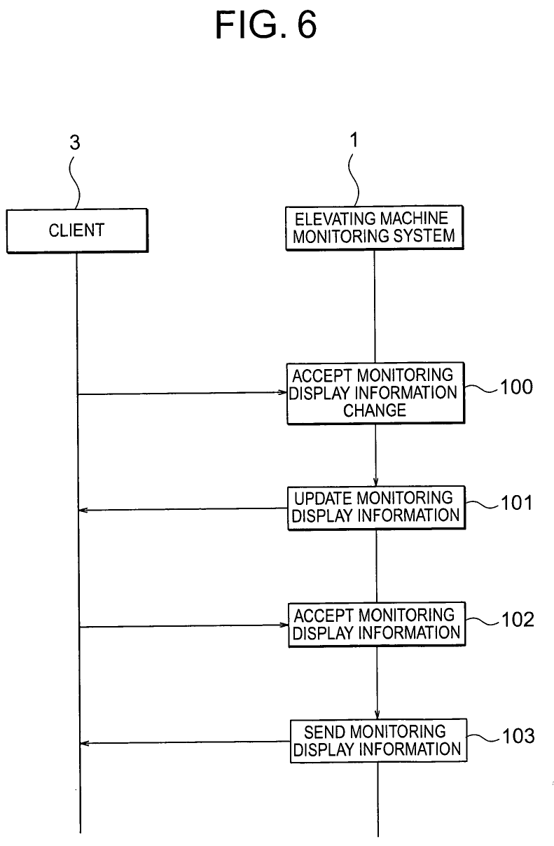

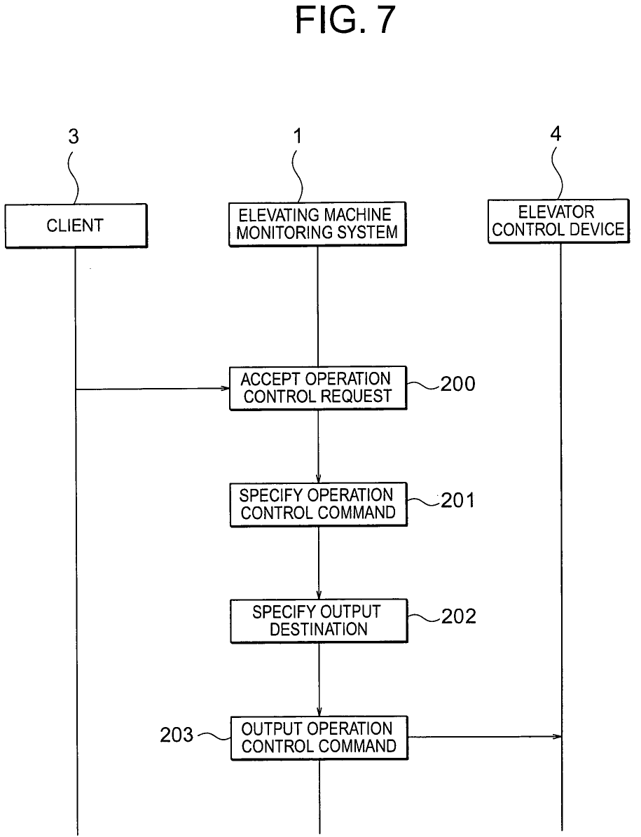

The explanation will now be given by referring back to FIG. 1. The CPU 12 performs overall control of the elevating machine monitoring system 1, and has the following means. That is, the CPU 12 has monitoring display information change accepting means 121, monitoring display information updating means 122, and monitoring display information transmission request accepting means 123. Further, the CPU 12 has monitoring display information displaying means 124 and language selecting means 125. In addition, the CPU 12 has operation control request accepting means 126, operation control request specifying means 127, and operation control command outputting means 128. It should be noted that the functions of each of the means are described hereinafter (refer to FIGS. 6 and 7).

A client 3 is a terminal in which a browser is installed. A personal computer is used therefor, for example.

An operation of the elevating machine monitoring system 1 is explained next. It should be noted that the elevating machine monitoring system 1 performs the following processes according to the elevating machine monitoring program of the elevating machine monitoring program file 116.

[Monitoring Display Information Display Process]

FIG. 6 is a flowchart that shows operations for allowing the client 3 to display monitoring display information, which are operations of the elevating machine monitoring system 1.

First, the operator operates the client 3 to establish an HTTP (Hyper Text Transfer protocol) connection to the elevating machine monitoring system 1, after which a monitoring display information change request is sent to the elevating machine monitoring system 1. The change request is a request for changing the name of the specific elevator 41, for example. An input system such as use of check boxes is adopted when making the change request. Once the request is made, in the elevating machine monitoring system 1 the monitoring display information change accepting means 121 accepts the monitoring display information change request through the communication network 2 (step 100).

The monitoring display information updating means 122 updates the monitoring display information, for which the change has been requested as described above, in the monitoring display information file 111 (step 101). An operator can thus freely change the monitoring display information, such as the machine name, for the specified elevator 41 as he/she likes.

After that, the operator operates the client 3 to establish an HTTP connection to the elevating machine monitoring system 1. Then, a monitoring display information transmission request is sent to the elevating machine monitoring system 1. An input system such as use of a send button etc. is adopted when making the transmission request. Once the request is made, in the elevating machine monitoring system 1 the monitoring display information transmitting means 123 accepts the monitoring display information transmission request from the client 3 (step 102).

The transmission request is received, and the monitoring display information displaying means 124 refers to the monitoring display information file 111, and sends the monitoring display information after updating, for which the transmission request has been made, to the client (external portion) 3, through the communication network 2 (step 103). The client 3 then displays the monitoring display information, after updating, on a display screen.

The operator can thus monitor the elevating machine while confirming the monitoring display information after updating. It therefore becomes possible to perform monitoring services for elevating machines such as elevators according to the demands of the operator (user).

[Display Language Selection Process]

The language selecting means 125 selects monitoring display information expressed in a specific language (English, for example) from among a plurality of languages (Japanese and English, for example) from within the monitoring display information file by language on the basis of language setting information (a setting code, for example) that is readout from the memory 11 during start-up of the elevating machine monitoring system 1.

In this case the monitoring display information displaying means 124 refers to the monitoring display information file by language 112 and allows the client 3 to display the monitoring display information expressed in the specific language (English, for example). It thus becomes possible to perform language display corresponding to the country where the elevating machine monitoring system 1 is shipped.

[Operation Control Command Output Process]

FIG. 7 is a flowchart that shows operations for outputting operation control commands to the elevating machine control devices, which are operations of the elevating machine monitoring system 1. The explanation made here is mainly for operation control commands relating to the elevators 41, but operation control commands relating to the escalator 51 are similar thereto.

First, the operator operates the client 3 to establish an HTTP connection to the elevating machine monitoring system 1, after which an operation control request relating to an elevating machine is sent to the elevating machine monitoring system 1. The operation control request is a request for stopping the specific elevator 41, for example. An input system such as use of checkboxes is adopted when making the stopping request. Once the request is made, in the elevating machine monitoring system 1 the operation control request accepting means 126 accepts the operation control request relating to the elevating machine from the client 3, through the communication network 2 (step 200).

The operation control request is received, and the operation control request specifying means 127 refers to the operation control command file 115 and specifies the operation control command requested for operation control (step 201). Further, the operation control request specifying means 127 refers to the elevating machine management mode file (the elevator management mode file 113, for example), and specifies the elevating machine control device as an output destination (the elevator control device 4, for example). The specified elevating machine control device controls the elevating machine (the elevator 41) for which operation control is requested. When specifying the elevating machine control device, the operation control request specifying means 127 specifies the elevator control device name of the elevator control device 41, which is the output destination, for example.

The operation control command outputting means 128 outputs the operation control command relating to the elevator 41, for which operation control is requested, to the elevating machine control device (the elevator control device 4) that the operation control request specifying means 127 has specified through the communication network 2 (step 203). When outputting the operation control command, the operation control command outputting means 128 outputs the operation control command to an IP address for the elevator control device 4 that has been read out from the elevator management mode file 113.

The elevator control device 4 that has received the operation control command from the elevating machine monitoring system 1 controls the elevator 41 for which operation control is requested, according to the operation control command to thereby stop the elevator 41, for example.

The operator can thus implement operation control for the elevating machine such as the elevator 41 as he/she likes. It therefore becomes possible to perform monitoring service for an elevating machine such as an elevator according to the demands of the operator (user).

The present invention is not limited to the embodiment described above. Although the system configuration in the embodiment described above is explained by using as an example a client and server type, the present invention is not limited to this. The system configuration may also be of stand-alone type, for example. In this case, the elevating machine monitoring system 1 accepts information from the input device 13 when accepting information (steps 100, 102, and 200 as mentioned above). Further, the elevating machine monitoring system 1 outputs information to the display device 14 when outputting information (steps 103 and 203 as mentioned above).

Further, although a case where the elevating machine monitoring system 1 and the elevating machine control device are separate devices is explained, the elevating machine monitoring system 1 may also be incorporated into the elevating machine control device.

In addition, although a case where the elevating machine monitoring system 1 performs processing by using a single CPU 12 is explained, the elevating machine monitoring system 1 may also perform distribution processing by using the plural CPUs 12. The memory 11 of the elevating machine monitoring system 1 may also be physically configured by using a plurality of memories.

Effects similar to those of the embodiment described above can also be obtained with the modifications explained above.

1. An elevating machine monitoring system, comprising:
monitoring display information storage means for storing monitoring display information relating to an elevating machine;
monitoring display information change accepting means for accepting a request for changing the monitoring display information;
monitoring display information updating means for updating the monitoring display information, for which a change has been requested, in the monitoring display information storage means;
monitoring display information transmission request accepting means for accepting a request for transmitting the monitoring display information; and
monitoring display information displaying means for displaying on an external display the monitoring display information after updating, for which transmission has been requested, by referring to the monitoring display information storage means.

2. The elevating machine monitoring system according to claim 1, wherein:
the monitoring display information storage means stores the monitoring display information expressed in a plurality of languages, for each language;
the system further comprises language selecting means for selecting the monitoring display information that is expressed in a specific language, from among the plurality of languages, when starting up the elevating machine monitoring system; and
the monitoring display information displaying means displays on the external display the monitoring display information that is expressed in the language selected by the language selecting means.

3. An elevating machine monitoring system, comprising:
operation control command storage means for storing an operation control command relating to an elevating machine;
elevating machine management mode storage means for storing associations between the elevating machine and an elevating machine control device that controls the elevating machine;
operation control request accepting means for accepting a request for operation control relating to the elevating machine;
operation control request specifying means for specifying an operation control command, which has been requested for operation control, by referring to the operation control command storage means, and for specifying an elevating machine control device, which controls the elevating machine for which operation control has been requested, by referring to the elevating machine management mode storage means; and
operation control command outputting means for outputting the operation control command specified by the operation control request specifying means and relating to the elevating machine for which operation control has been requested, to the elevating machine control device specified by the operation control request specifying means, for controlling the elevating machine for which operation control has been requested according to the operation control command.

4. A computer readable recording medium having an elevating machine monitoring program recovered thereon, the elevating machine monitoring program causing:
monitoring display information change accepting means to accept a request for changing monitoring display information;
monitoring display information updating means to update monitoring display information, for which change has been requested in monitoring display information storage means;
monitoring display information transmission request accepting means to accept a request for transmitting the monitoring display information; and
monitoring display information displaying means to display on an external display the monitoring display information after updating, for which transmission has been requested, by referring to the monitoring display information storage means that stores the monitoring display information relating to the elevating machine.

5. The computer readable recording medium having an elevating machine monitoring program recorded thereon according to claim 4 wherein:
the monitoring display information storage means stores the monitoring display information expressed in a plurality of languages for each language; and
the elevating machine monitoring program causes:
language selecting means to select the monitoring display information that is expressed in a specific language, from among the plurality of languages, when starting up an elevating machine monitoring system; and
monitoring display information displaying means to display on the external display the monitoring display information that is expressed in the language selected by the language selecting means.

6. A computer readable recording medium having an elevating machine monitoring program recorded thereon, the elevating machine monitoring program causing:
operation control request accepting means to accept an operation control request relating to an elevating machine;
operation control request specifying means to specify an operation control command, which has been requested for operation control, by referring to operation control command storage means that stores operation control commands relating to the elevating machine, and specifying an elevating machine control device that controls the elevating machine, for which operation control has been requested, by referring to elevating machine management mode storage means that stores associations between the elevating machine and the elevating machine control device that controls the elevating machine; and
operation control command outputting means to output the operation control command specified by the operation control request specifying means and relating to the elevating machine, for which operation control has been requested, to the elevating machine control device specified by the operation control request specifying means for controlling the elevating machine, for which operation control has been requested, according to the operation control command.
